(19) United States
(12) Patent Application Publication
(10) Pub. No.: US 2019/0216028 A1
(43) Pub. Date: Jul. 18, 2019

(54) PLANT CULTIVATING APPARATUS

(71) Applicants: Fu-Hsiang Ho, Changhua (TW); Tsair-Rong Chen, Changhua (TW); Po-Hsuan Chen, Changhua (TW); Yu-Lin Juan, Changhua (TW); Yi-Lung Lee, Taichung City (TW)

(72) Inventors: Fu-Hsiang Ho, Changhua (TW); Tsair-Rong Chen, Changhua (TW); Po-Hsuan Chen, Changhua (TW); Yu-Lin Juan, Changhua (TW); Yi-Lung Lee, Taichung City (TW)

(73) Assignees: RAY CHUAN ENTERPRISE CO., LTD., Changhua (TW); Department of Electrical Engineering, National Changhua University of Education, Changhua (TW)

(21) Appl. No.: 15/871,974

(22) Filed: Jan. 15, 2018

(51) Int. Cl. A01G 31/06; A01G 24/40

(52) U.S. Cl. CPC A01G 31/06; A01G 2031/006; A01G 24/40

(57) ABSTRACT

A plant cultivating apparatus may comprise a cultivating unit, a plurality of cultivating cups, a nutrient bucket, a motor, a temperature adjusting unit, a temperature and humidity sensor, and a control unit. The control unit, which is electrically connected to the motor, the temperature adjusting unit and the sensor, is configured to receive environmental data such as temperature and humidity from the sensor and to turn on/off the motor or/and the temperature adjusting unit according to the received data.

### FIELD OF THE INVENTION

The present invention relates to a plant cultivating apparatus and more particularly to an intelligent plant cultivating apparatus.

### BACKGROUND OF THE INVENTION

Hydroponics is a cultivating technology to put roots of a plant in a nutrient solution, and the plant can obtain nutrients and needed elements from the nutrient solution for growth. Although the plant can obtain nutrients from the nutrient solution, the absorption process goes not very fast. Thus, the cultivator needs to frequently change the nutrient solution to avoid breeding of bacteria in the nutrient solution, and for a long term, it may cause the wastes of water and other resources. Moreover, the roots of the plant is prone to be rotted when continuously soaking in the nutrient solution for a long period of time. Thus, a cultivating technology is invented which cultivates the plant in a cultivating cup and uses spray technology to provide nutrient for the plant.

However, the conventional cultivating technology is disadvantageous because: the roots of the plant are prone to grow out of the cultivating cup from lateral holes thereof, and when the plant needs to be transplanted to continuously cultivate on a positioning plate, the roots are easily be cut or broken by the positioning plate, thereby affecting its growth and development. Therefore, there remains a need for a new and improved design for a plant cultivating apparatus to overcome the problems presented above.

### SUMMARY OF THE INVENTION

The present invention provides a plant cultivating apparatus which comprises a cultivating unit, a plurality of cultivating cups, a nutrient bucket, a motor, a temperature adjusting unit, a temperature and humidity sensor, and a control unit. The control unit is electrically connected to the motor, the temperature adjusting unit and the sensor. The control unit is configured to receive environmental data such as temperature and humidity from the sensor and according to the received data to turn on/off the motor or/and the temperature adjusting unit. The cultivating unit comprises a housing, and a plurality of top openings are formed at a top surface of the cultivating unit to communicate with the housing. A spray pipe connected to the nutrient bucket is positioned in the housing, and a plurality of spray holes are formed on the spray pipe. The nutrient solution stored in the nutrient bucket is adapted to be pumped by the motor to flow through the spray pipe and evenly and upwardly spray out of the spray holes toward the top openings. Each of the cultivating cups comprises a bottom portion and a peripheral wall which are coupled together to form an interior space therein. A top end of the cultivating cup has a flange coupled around an opening of the cultivating cup, and when the cultivating cup is put into the housing of the cultivating unit through the top opening, the flange is configured to couple with a top edge of the top opening of the cultivating unit to enable the cultivating cup to be suspended. Moreover, the bottom portion of the cultivating cup has a plurality of bottom holes, and the peripheral wall of the cultivating cup comprises a plurality of lateral openings vertically extending from a middle portion to an upper portion of the peripheral wall. A lower portion of the peripheral wall which is located below the lateral openings is sealed, and a planting material with a sponge is positioned into the interior space of the cultivating cup and placed on the bottom portion for spray cultivation. Each of the cultivating cups is configured to cooperate with the cultivating unit, the nutrient bucket, the motor, the temperature adjusting unit and the temperature and humidity sensor to carry out the spray cultivation.

Comparing with conventional cultivating method or apparatus, the present invention is advantageous because: (i) the nutrient spray is configured to come from each of the bottoms portions of the cultivating cups, and the lower portion of the cultivating cup is sealed, which ensures roots of the planting material to only grow downwardly, thereby preventing the roots from been damaged during transplant; and (ii) the temperature and humidity sensor is configured to monitor the environmental conditions around the cultivating unit to not only cultivate the planting materials in optimum conditions but also reduce labors and costs.

### BRIEF DESCRIPTION OF THE DRAWINGS

FIG. 1 is a three-dimensional assembly view of a plant cultivating apparatus of the present invention.

FIG. 2 is a three-dimensional view of a cultivating cup of the plant cultivating apparatus of the present invention.

FIG. 3 is a three-dimensional view of another embodiment of the cultivating cup of the plant cultivating apparatus in the present invention.

FIG. 4 is a schematic view of the plant cultivating apparatus when nutrient solution in a nutrient bucket is sprayed out of spray holes of a spray pipe toward the cultivating cups in the present invention.

FIG. 5 is a schematic view illustrating the cultivating cup of the plant cultivating apparatus is moved out from the cultivating unit.

FIG. 6 is a schematic view illustrating the cultivating cup of the plant cultivating apparatus is moved and coupled on a positioning plate.

FIG. 7 is a three-dimensional assembly view of another embodiment of the plant cultivating apparatus in the present invention.

FIG. 8 is a schematic view illustrating the nutrient solution falls or drips back into the nutrient bucket of the plant cultivating apparatus for reuse.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

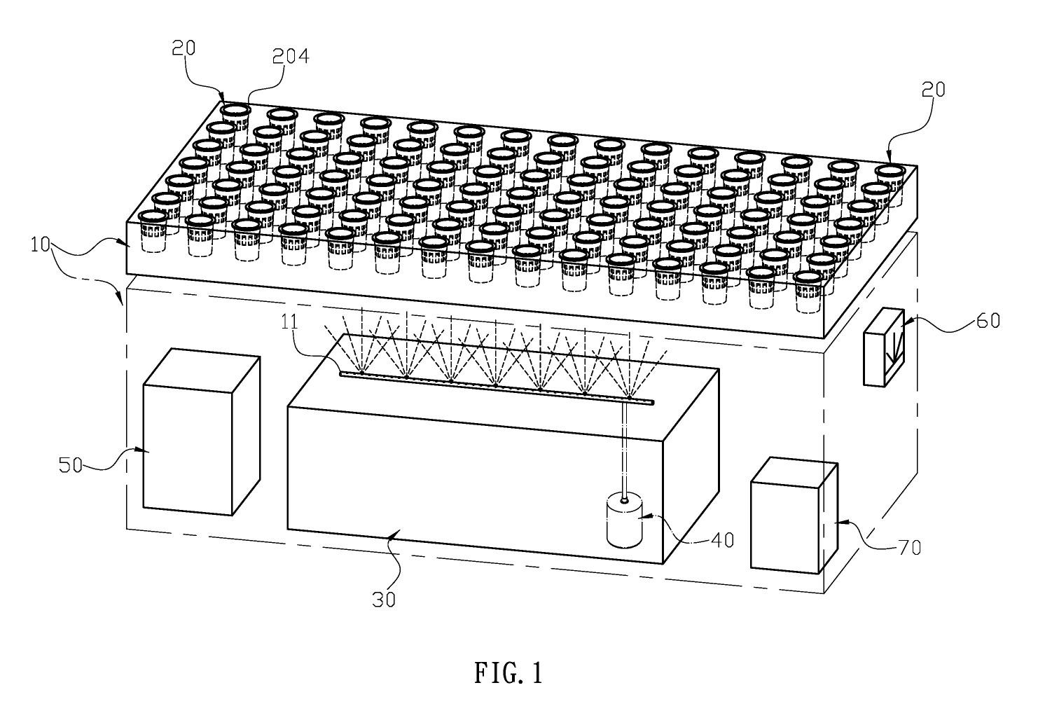

Referring to FIGS. 1 to 4, the present invention provides a plant cultivating apparatus which comprises a cultivating unit (10), a plurality of cultivating cups (20), a nutrient bucket (30), a motor (40), a temperature adjusting unit (50), a temperature and humidity sensor (60), and a control unit (70). The control unit (70) is electrically connected to the motor (40), the temperature adjusting unit (50) and the sensor (60). The control unit (70) is configured to receive environmental data such as temperature and humidity from the sensor (60) and according to the received data to turn on/off the motor (40) or/and the temperature adjusting unit (50). The cultivating unit (10) comprises a housing (101), and a plurality of top openings (102) are formed at a top surface of the cultivating unit (10) to communicate with the housing (101). A spray pipe (11) connected to the nutrient bucket (30) is positioned in the housing (101), and a plurality of spray holes are formed on the spray pipe (11). The nutrient solution stored in the nutrient bucket (30) is adapted to be pumped by the motor (40) to flow through the spray pipe (11) and evenly and upwardly spray out of the spray holes toward the top openings (102). Each of the cultivating cups (20) comprises a bottom portion (201) and a peripheral wall (202) which are coupled together to form an interior space (203) therein. A top end of the cultivating cup (20) has a flange (204) coupled around an opening of the cultivating cup (20), and when the cultivating cup (20) is put into the housing (101) of the cultivating unit (10) through the top opening (102), the flange (204) is configured to couple with a top edge of the top opening (102) of the cultivating unit (10) to enable the cultivating cup (20) to be suspended. Moreover, the bottom portion (201) of the cultivating cup (20) has a plurality of bottom holes (205), and the peripheral wall (202) of the cultivating cup (20) comprises a plurality of lateral openings (206) vertically extending from a middle portion to an upper portion of the peripheral wall (202). A lower portion of the peripheral wall (202) which is located below the lateral openings (206) is sealed, and a planting material (80) with a sponge (21) is positioned into the interior space (203) of the cultivating cup (20) and placed on the bottom portion (201) for spray cultivation.

In one embodiment, the cultivating unit (10) is a storage box (as shown in FIG. 1).

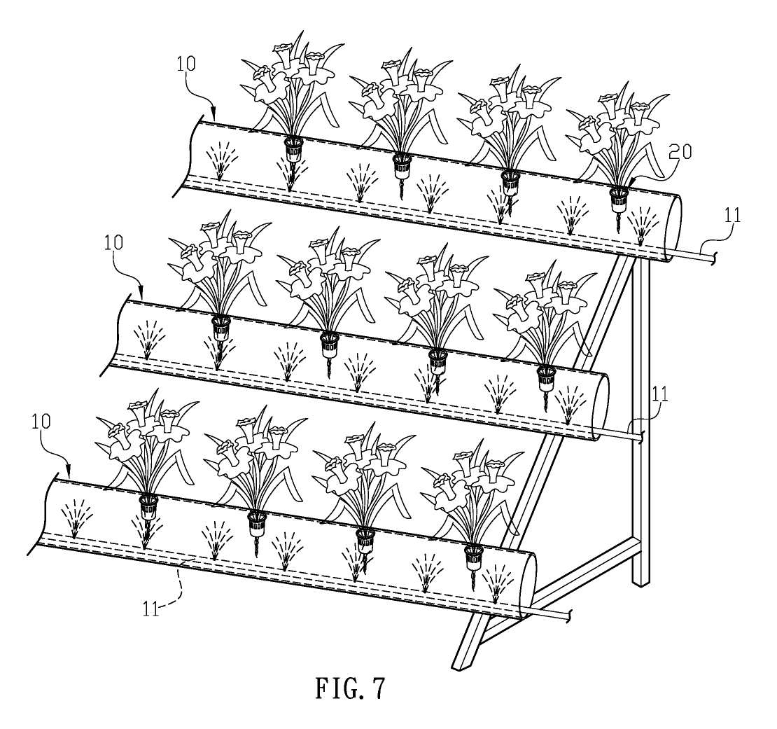

In another embodiment, the cultivating unit (10) is a pipe (as shown in FIG. 7).

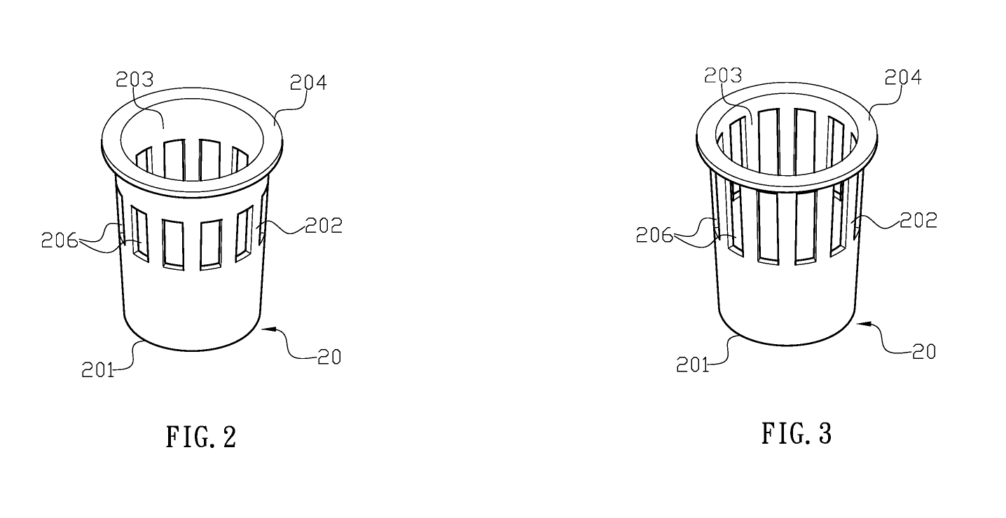

In still another embodiment, each of the lateral openings (206) is vertically extended from the middle portion to the upper portion of the peripheral wall (202), and an upper end of the lateral opening (206) is located away from to the flange (204) (as shown in FIG. 2).

In a further embodiment, each of the lateral openings (206) is vertically extended from the middle portion to the upper portion of the peripheral wall (202), and the upper end of the lateral opening (206) is located close to the flange (204) (as shown in FIG. 3).

In still a further embodiment, the planting material (80) is a seed of a plant.

In a preferred embodiment, the planting material (80) is a seedling of a plant.

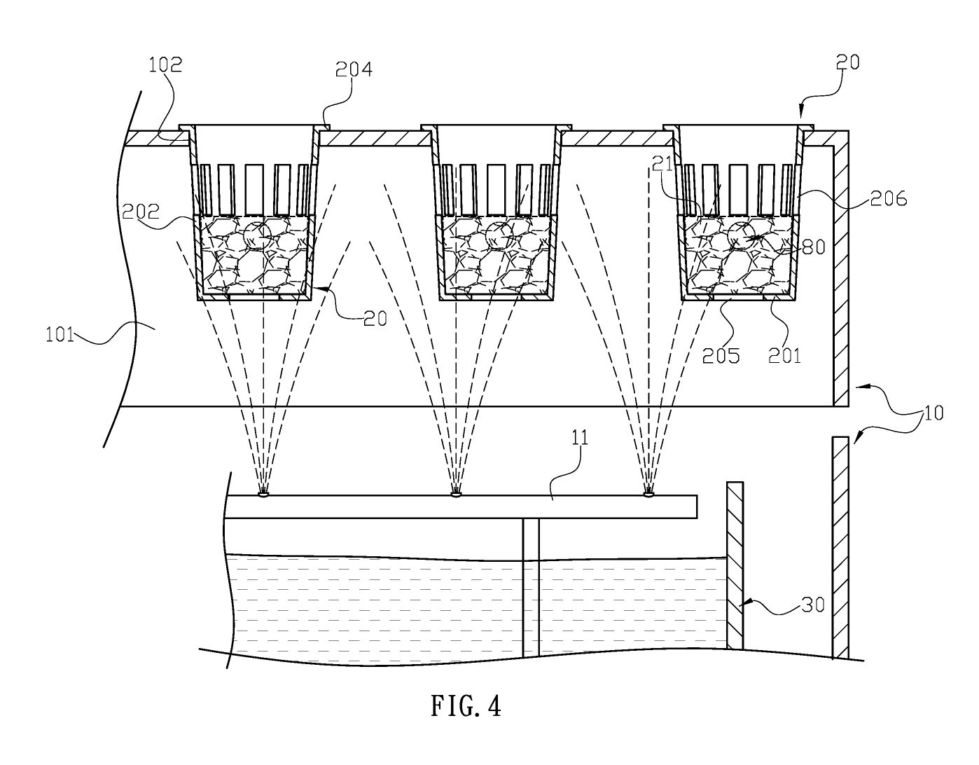

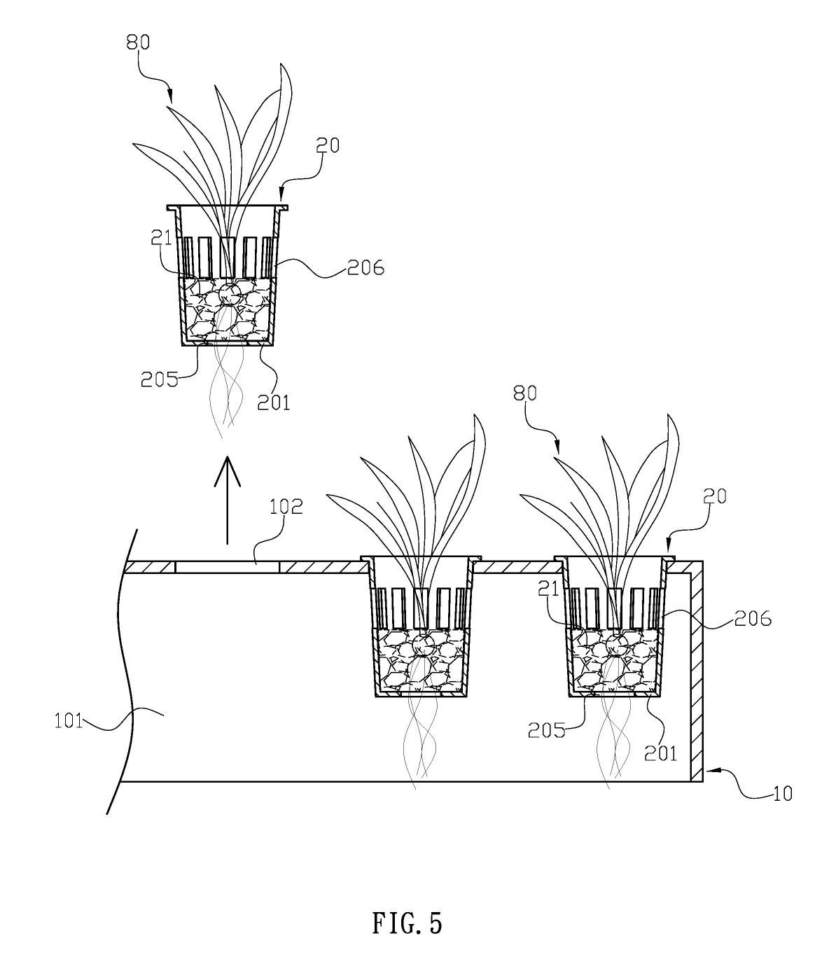

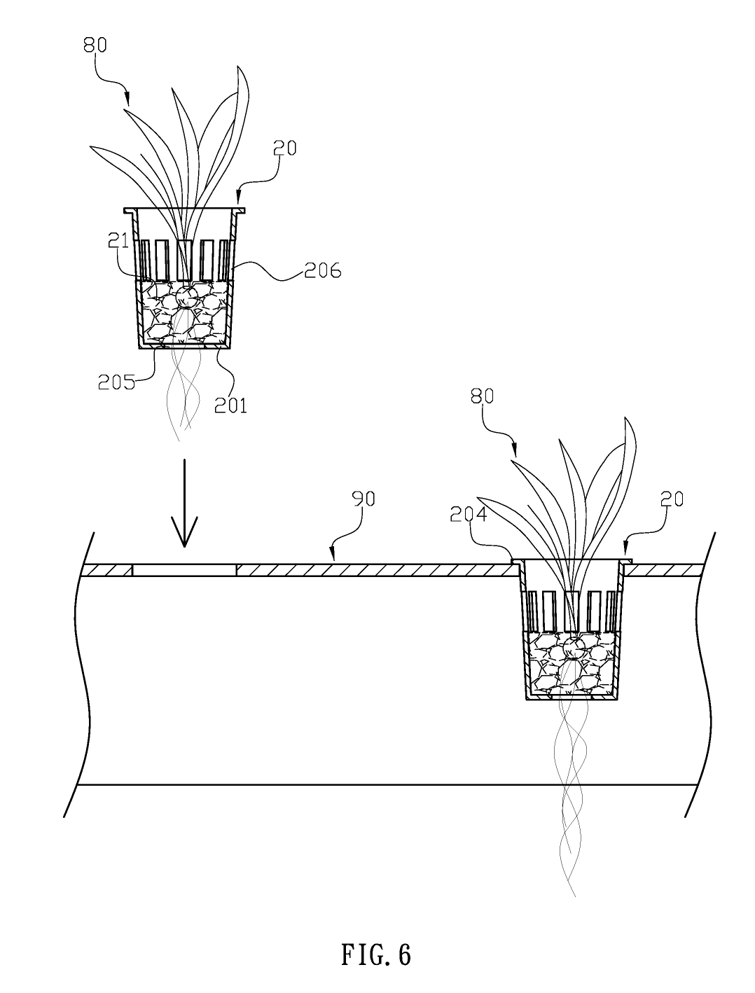

In actual application, referring to FIG. 4, the present invention cultivates the planting materials (80) by the nutrient solution in the nutrient bucket (30) which is sprayed upwardly through the spray pipe (11). The sprayed nutrient solution is configured to get into each of the cultivating cups (20) through the lateral openings (206) and the bottom holes (205) thereof, and also the sponge (21) in the cultivating cup (20) is adapted to soak the nutrient solution. After the spraying is stopped, the nutrient solution can slowly flow out of the sponge (21) to provide nutrient for the planting material (80), which enables roots of the planting material (80) evenly grow downward. Also, since the lower portion of the peripheral wall (202) of the cultivating cup (20) is sealed, the roots of the planting material (80) is adapted to only protrude from the bottom holes (205), which prevents the roots from been damaged by the cultivating unit (10) or the positioning plate (90) during transplant (as shown in FIGS. 5 and 6). Moreover, the temperature and humidity sensor (60) can measure and send the environmental data around the cultivating unit (10) to the control unit (70), and the control unit (70) can adjust the spraying time and amount of the nutrient solution from the nutrient bucket (30) according to the received data. For example, when the surrounding temperature is higher and/or the surrounding humidity is lower, the control unit (70) is configured to extend the spraying time. Furthermore, the control unit (70) also can control the temperature adjusting unit (50) to heat or cool the nutrient solution in the nutrient bucket (30) so as to keep the nutrient solution in an optimum cultivating temperature (20-23). In addition, the prevent invention of the plant cultivating apparatus not only cultivates the planting materials (80) in optimum conditions but also reduces labors and costs.

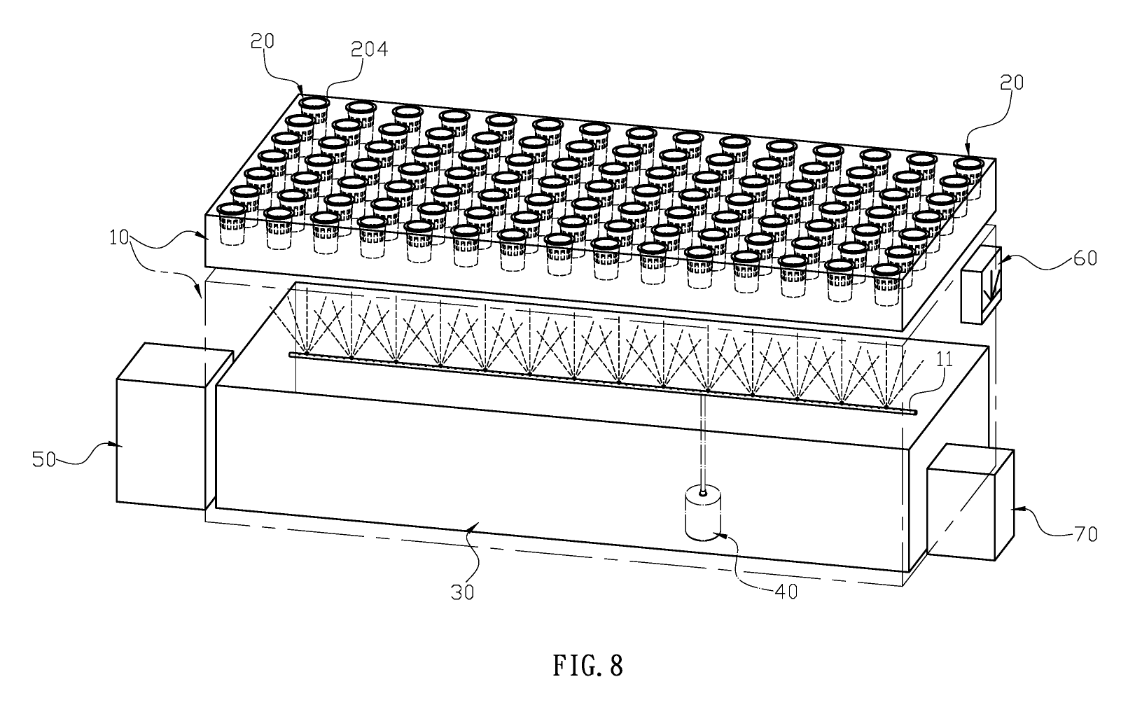

Besides, since the nutrient solution is sprayed upwardly, the nutrient bucket (30) is adapted to catch dripping and falling nutrient solution for reuse (as shown in FIG. 8).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A plant cultivating apparatus comprising a cultivating unit, a plurality of cultivating cups, a nutrient bucket, a motor, a temperature adjusting unit, a temperature and humidity sensor, and a control unit; the control unit, which is electrically connected to the motor, the temperature adjusting unit and the sensor, configured to receive environmental data such as temperature and humidity from the sensor and to turn on/off the motor or/and the temperature adjusting unit according to the received data;
wherein the cultivating unit comprises a housing, and a plurality of top openings are formed at a top surface of the cultivating unit to communicate with the housing; a spray pipe connected to the nutrient bucket is positioned in the housing, and the nutrient solution stored in the nutrient bucket is adapted to be pumped by the motor to flow through and evenly spray out of the spray pipe toward the top openings; and
wherein each of cultivating cups comprises a bottom portion and a peripheral wall which are coupled together to form an interior space therein; a top end of the cultivating cup has a flange coupled around an opening of the cultivating cup, and when the cultivating cup is put into the housing of the cultivating unit through the top opening, the flange is configured to couple with a top edge of the top opening of the cultivating unit to enable the cultivating cup to be suspended on the cultivating unit; the bottom portion of the cultivating cup has a plurality of bottom holes, and the peripheral wall of the cultivating cup comprises a plurality of lateral openings vertically extending from a middle portion to an upper portion of the peripheral wall; a lower portion of the peripheral wall which is located below the lateral openings is sealed, and a planting material with a sponge is positioned into the interior space of the cultivating cup and placed on the bottom portion of the cultivating cup for spray cultivation; and each of the cultivating cups is configured to cooperate with the cultivating unit, the nutrient bucket, the motor, the temperature adjusting unit and the temperature and humidity sensor to carry out the spray cultivation.

2. The plant cultivating apparatus of claim 1, wherein the cultivating unit is a storage box.

3. The plant cultivating apparatus of claim 1, wherein the cultivating unit is a pipe.

4. The plant cultivating apparatus of claim 1, wherein each of the lateral openings is vertically extended from the middle portion to the upper portion of the peripheral wall, and an upper end of the lateral opening is located away from the flange.

5. The plant cultivating apparatus of claim 1, wherein each of the lateral openings is vertically extended from the middle portion to the upper portion of the peripheral wall, and an upper end of the lateral opening is located close to the flange.

6. The plant cultivating apparatus of claim 1, wherein the planting material is a seed of a plant.

7. The plant cultivating apparatus of claim 1, wherein the planting material is a seedling of a plant.

8. The plant cultivating apparatus of claim 1, wherein the nutrient solution upwardly sprayed from the spray pipe is adapted to drip and fall back into the nutrient bucket for reuse.
